(19) United States
(12) Patent Application Publication
(10) Pub. No.: US 2010/0030791 A1
(43) Pub. Date: Feb. 4, 2010

(54) SYSTEMS AND METHODS FOR POWER AWARE DATA STORAGE

(75) Inventors: Steven Ross Iverson, Oceanside, CA (US); Jonathan Francis Sedore Kay, Kitchener (CA); Patricia Lee Harris, Palo Alto, CA (US)

Correspondence Address: PROCOPIO, CORY, HARGREAVES & SAVITCH LLP, 530 B STREET, SUITE 2100, SAN DIEGO, CA, 92101, US

(73) Assignee: DIOMEDE CORPORATION, San Diego, CA (US)

(21) Appl. No.: 12/512,839

(22) Filed: Jul. 30, 2009

Related U.S. Application Data
(60) Provisional application No. 61/137,347, filed on Jul. 30, 2008.

(51) Int. Cl. G06F 17/30; G06F 12/00

(52) U.S. Cl. 707/10; 707/205; 707/201; 707/E17.01

(57) ABSTRACT

A power aware data storage system comprises storage configured to store physical data files, the storage comprising several types of storage that are associated with different access times and power consumption; a storage authority coupled with the storage, the storage authority configured to control uploading of files to the storage, and downloading of files from the storage; web services configured to interface the storage authority with end users via the internet and to allow the end users to select the type of storage for each physical file or group of physical files; and a power consumption application configured to compute power consumption information for each physical data file stored in the storage and to report the power consumption information via the web services.

### RELATED APPLICATIONS INFORMATION

This application claims the benefit under 35 U.S.C. §119(e) of U.S. Provisional Application Ser. No. 61/137,347, filed Jul. 30, 2008 and entitled “Multi-Tiered, Power Consumption Aware, Content Addressable Data Storage Device and Service,” and which is incorporated herein by reference in its entirety as if set forth in full.

### BACKGROUND

1. Technical Field

The embodiments described herein generally relate to online data storage, and more particularly to power aware data storage.

2. Related Art

Businesses generate a significant amount of data that requires storage and delivery. Large corporations have responded by building massive data centers that consume huge amounts of power and generate large amounts of heat. As a result of all this power consumption, the world's data centers are projected to surpass the airline industry as a greenhouse gas polluter by 2020, according to a McKinsey report. Data storage devices are one of the largest consumers of power within data centers.

“Cloud storage” is a new, emerging market within the $90 B data storage industry. Cloud storage services are positioned to replace many traditional storage hardware vendors that require businesses to purchase, install, manage, and power their own hardware in their own datacenters. By using cloud storage services, companies can gain access to similar storage functionality that their hardware provided (and more), but via the Internet and on a pay-per-use basis. Cloud storage is also a significant opportunity in emerging markets where companies are especially eager to gain access to scalable infrastructure at a low entry cost.

Cloud storage services are distinct from “online storage” and “online backup” markets, which were developed over the last decade. Cloud storage is scale-on-demand storage and bandwidth infrastructure provided as a programmatically-accessible service; it is not an end-user application or product. In fact, some online storage companies such as SmugMug, Elephant Drive, and FreeDrive have built their products using cloud storage service providers. But these online storage companies represent just a fraction of the cloud storage market opportunity.

First generation cloud storage services like Amazon S3 provide a one-size-fits-all storage option—hosted photos, backups, compliance email, CDN content origin data, virtual machine images, etc., are all treated and priced the same. In other words, each type of data is handled as though it needs to be instantly available 24/7, even if the user can actually withstand some delay when accessing the data, especially if there is lower cost associated with a short delay.

### SUMMARY

A power aware data storage system that includes several types of storage associated with different access times and different power consumption and that can measure the amount of power consumed by each stored file is disclosed herein.

According to one aspect, a power aware data storage system comprises storage configured to store physical data files; a storage authority coupled with the storage, the storage authority configured to control uploading of files to the storage, and downloading of files from the storage; web services configured to interface the storage authority with end users; and a power consumption application configured to compute power consumption information for each physical data file stored in the storage and to report the power consumption information via the web services

According to another aspect, a power aware data storage system comprises storage configured to store physical data files, the storage comprising several types of storage that are associated with different access times and power consumption; a storage authority coupled with the storage, the storage authority configured to control uploading of files to the storage, and downloading of files from the storage; web services configured to interface the storage authority with end users via the internet and to allow the end users to select the type of storage for each physical file or group of physical files; and a power consumption application configured to compute power consumption information for each physical data file stored in the storage and to report the power consumption information via the web services

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an example power aware data storage system in accordance with one embodiment;

FIG. 2 is a diagram illustrating various performance and cost tradeoffs associated with different types of storage that can be included in the system of FIG. 1;

FIG. 3 is a diagram illustrating the system of FIG. 1 in more detail in accordance with one embodiment;

FIG. 4 is a flow chart illustrating an example process for uploading a file in the system of FIG. 1 in accordance with one embodiment; and

FIG. 5 is a diagram illustrating storage authority that can be included in the system of FIG. 1 in accordance with one embodiment.

### DETAILED DESCRIPTION

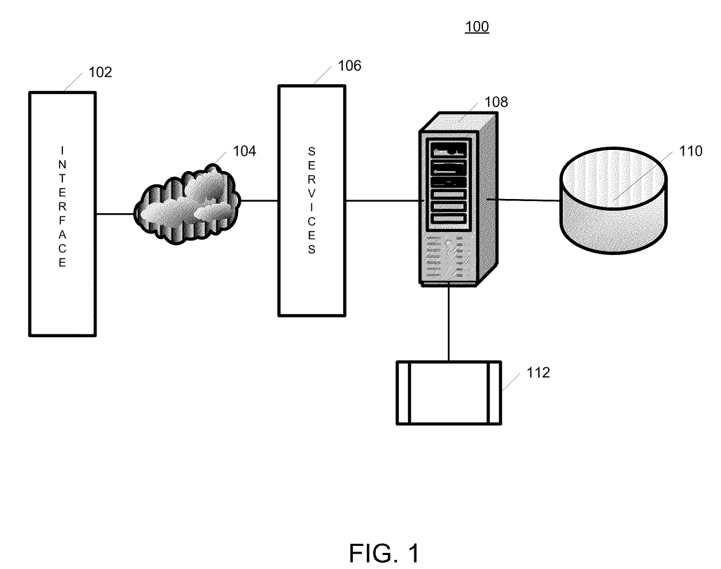

FIG. 1 is a diagram illustrating an example power aware data storage system 100 in accordance with one embodiment. System 100 comprises an interface 102, network 104, services 106, storage authority 108, storage 110, and applications 112. Interface 102 can comprise software interfaces and applications that allow a user to interface with the rest of system 100 to store data in storage 110. For example, there are several companies that design end-user, online storage applications. Such applications can be used to provide interface 102. Interface 102 can implement industry standard web service interfaces, such as SOAP, REST, and WCF protocols.

Network 104 can comprise one or more wired or wireless networks, such as a Wide Area Network (WAN), Local Area Network (LAN), or combinations thereof. Network 104 can be configured to provide access to storage 110. It can be preferable for network 104 to enable access to storage 110 via the Internet and World Wide Web due to the wide availability and standardization of both. Also, many interfaces 102 are designed to operate via, or in conjunction with the Internet.

Services 106 are a set of services configured to manage how data is stored, accessed, and manipulated within system 100. Services 106 can be configured to run on, or be hosted by authority 108 and can include, e.g., web services, download services, storage services, a server database, background processes, and administrative services. These services are described in more detail below.

Storage authority 108 comprises all of the hardware and software needed to host services 106, and applications 112, and to interface with storage 110. As such, authority 108 comprises all of the processors, servers, such as file servers and application servers, routers, API's, services, applications, user interfaces, operating systems, middleware, telecommunications interfaces, etc., needed to perform the functions described herein. It will be understood that these components can be located at a single location or distributed across multiple locations. Moreover, a single server or processor can perform multiple functions or tasks described herein, or these functions or tasks can be handled by separate servers or processors. It will also be understood that services 106 and applications 112 can be part of authority 108 although they are referred to separately herein to aid in the description of system 100.

Storage 110 can comprise various storage media configured to store data for a plurality of users. Storage 110 is not primary storage, rather it is secondary or tertiary storage and can comprise online storage, offline storage, and more often both. Secondary storage differs from primary storage in that it is not directly accessible by the user's Central Processing Unit (CPU), or computer. The computer usually uses its input/output channels to access secondary storage and transfers the desired data using intermediate area in primary storage. Secondary storage does not lose the data when the device is powered down, i.e., it is non-volatile. Per unit, it is typically also an order of magnitude less expensive than primary storage. Consequently, conventional computer systems typically have an order of magnitude more secondary storage than primary storage and data is kept for a longer time in secondary storage.

Conventionally, hard disks are usually used as secondary storage. The time taken to access a given byte of information stored on a hard disk is typically a few thousandths of a second, or milliseconds. By contrast, the time taken to access a given byte of information stored in random access memory, i.e., primary storage, is measured in billionths of a second, or nanoseconds. This illustrates the very significant access-time difference that distinguishes solid-state memory from rotating magnetic storage devices: hard disks are typically about a million times slower than memory. Rotating optical storage devices, such as CD and DVD drives, have even longer access times.

Some other examples of secondary storage technologies are: solid state hard disks (SSDs), flash memory, e.g. USB sticks or keys, floppy disks, magnetic tape, paper tape, punch cards, standalone RAM disks, and Zip drives.

Secondary storage is often formatted according to a file system format, which provides the abstraction necessary to organize data into files and directories, providing also additional information (called metadata) describing the owner of a certain file, the access time, the access permissions, and other information. The file system format and metadata used in system 100 is described in more detail below.

Most computer operating systems use the concept of virtual memory, allowing utilization of more primary storage capacity than is physically available in the system. As the primary memory fills up, the system moves the least-used chunks (pages) to secondary storage devices, e.g., to a swap file or page file, retrieving them later when they are needed. As more of these retrievals from slower secondary storage are necessary, the more the overall system performance is degraded. But as noted below, sometimes that is acceptable.

Tertiary storage or tertiary memory, provides a third level of storage. Typically it involves a robotic mechanism which will mount (insert) and dismount removable mass storage media into a storage device according to the system's demands; this data is often copied to secondary storage before use. It is primarily used for archival of rarely accessed information since it is much slower than secondary storage, e.g. 5-600 seconds vs. 1-10 milliseconds. This is primarily useful for extraordinarily large data stores, accessed without human operators.

Off-line storage, also known as disconnected storage, is computer data storage on a medium or a device that is not under the control of a processing unit. The medium is recorded, usually in a secondary or tertiary storage device, and then physically removed or disconnected. It must be inserted or connected by a human operator before a computer can access it again. Unlike tertiary storage, it cannot be accessed without human interaction.

An advantage of off-line storage is that it increases general information security, since it is physically inaccessible from a computer, and data confidentiality or integrity cannot be affected by computer-based attack techniques. Also, if the information stored for archival purposes is accessed seldom or never, off-line storage is less expensive than tertiary storage.

In modern personal computers, most secondary and tertiary storage media are also used for off-line storage. Optical discs and flash memory devices are most popular, and to much lesser extent removable hard disk drives. In enterprise uses, magnetic tape is predominant. Older examples are floppy disks, Zip disks, or punched cards.

Cloud storage services are designed to offer secondary, and possibly tertiary, storage as a service accepted through, e.g., the Internet. This way the user does not need to maintain a data center. Thus, storage 110 can comprise a plurality of storage servers and other mass storage devices. Unlike conventional cloud storage services, applications 112 can include applications that can compute the power consumption associated with data stored in storage 110. As will be explained, this information can then be used by the end user to manage the end user's data storage requirements.

Accordingly, end users can access storage 110 through interface 102 in order to meet their data storage needs. Unlike conventional systems, however, storage authority 108 can compute the energy consumption associated with storage of the data and can provide different storage options to the user based on energy consumption. Thus, system 100 can be an energy-efficient, e.g., cloud storage system designed for the long-term storage of archival and backup data. Storage system 100 can provide application developers and businesses the ability to integrate cost-effective, scale storage capabilities into their product, service, or IT processes. As will explained, end users can programmatically move data between different storage types, e.g., online, nearline, and offline, to best match each files' specific storage requirement. The primary tradeoffs between each storage type are cost, access time, and power consumption.

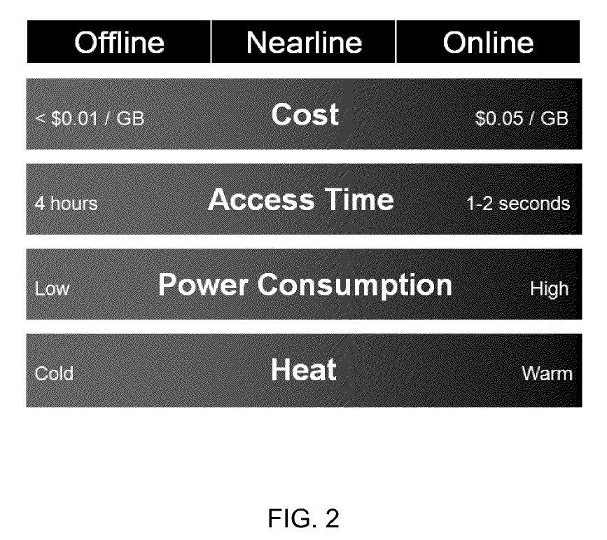

These tradeoffs can be illustrated in the chart of FIG. 2. As can be seen, the storage costs can be implemented such that they increase as the storage type selected goes from offline to online. But the access time moves in the opposite direction, i.e., online access times can be very fast, while offline access times are relatively slow; however, for certain types of data, the offline, or nearline, delay from a request for the data to the data's availability may be acceptable, especially given the lower cost. It should also be noted that the power consumption for offline storage is low, which is one reason it can be offered at lower costs. Thus, not only can offline storage save the end user money, it can reduce power consumption. Offline storage, or nearline storage, can also reduce the amount of heat generated, which is also good for the environment.

It will be understood that while three storage categories or variations thereof, e.g., online, nearline, and offline, are illustrated and described with the respect to the embodiments described herein, more levels can be supported as required. In other words, the use of three categories or levels herein is by way of example only and should not be seen as limiting the embodiments described herein in any way.

Accordingly, storage authority 108, or more particularly applications 112, can be capable of providing the energy consumption required to support a stored data object or set of objects. This allows the end user to be aware of the amount of power required to maintain a particular data set, and to make decisions based on that data. In conventional systems, IT administrators are able to make decision based solely on how much disk space (bytes) they consumed.

For example, applications 112 can provide the following characteristics to be reported for a given data object:

| | |
|---|---|
| Filename: | image001.jpg; |
| File size: | 82,232 bytes; |
| Power consumption rate: | 831.1 milliwatts; and |
| Total power consumed: | 3.2 watt hours. |

Applications 112 can also generate forecasts based on available and used power consumption. Conventionally, data storage capacity forecasts are made based on how much floor space, cabinet space, or physical hard disk space is available. With the systems and methods described herein, the storage administrator knows how much power a unit of storage consumes, and they know how much power is available to them. Accordingly, the administrator can compute, for example, maximum storage capacity based on available power. This is important because available power has become a limiting factor for many data storage installations.

As a result of having access to the power consumption information, a “hybrid” data storage service can be provided that allows the end-user programmatic access to various types of data storage devices, each with its own fee and performance characteristics. Data storage types can be defined on a per file or groups of files basis. For example, system 100 can make four (4) types of storage available for end user to access:

i. Online—$0.15/GB/mo—files instantly available, no backup;

ii. Nearline #1—$0.05/GB/mo—files available for download with 5 minutes, no backup;

iii. Nearline #2—$0.01/GB/mo—files available for download with 24 hours, no backup; and

iv. Backup (offline)—$0.03/GB/mo—files available for download with 24 hours, backed and guaranteed to never lose any data.

As can be seen, the price of the storage goes down as the power consumption goes down. Again, these categories are by way of example only and other categories, sub-categories, variations, and structures can be supported.

The user can then specify what storage type they desire for various files, or how many copies of a single file they would like on each storage type. This allows the end user to precisely control the performance characteristics of their stored data. Storing different numbers of copies of files on different storage tiers allows the user to adjust the following data performance characteristics:

i. Time to first byte;

ii. Data integrity (chance of data loss);

iii. Maximum available throughput (number of simultaneous users);

iv. Total power consumed by the file;

v. Recovery time objective—if there is a failure how long will it take to restore a copy; and

vi. Recovery point objective—how up-to-date is the most recent backup of a file.

Storage authority 108 can also be configured to support programmatic requests for manual intervention. For example, authority 108 can be configured to allow an end-user, i.e. an IT administrator, to programmatically move files between different storage types, or categories. Some of these storage types may involve manual intervention on the server-side, e.g., they may involve technicians or a robot, e.g., for an automated tape library changer. For example, if the user requests to move a file to a tape device that requires a tape to be inserted, or the user requests to read a file from a hard disk that is currently not connected to a server, then some type of manual or robotic intervention is necessary. Storage authority 108 can be configured to allow the end user to make requests for all files, even if they are powered down and not connected to the storage service. Authority 108 can in turn create a queue to handle the requests. Further, authority 108 can be configured to programmatically notify the end-user application when the file is available for download.

Authority 108 can also be configured to queue requests based on available power. Because authority 108 allows end-users to either programmatically power on offline servers, e.g. nearline storage, or make requests that, e.g., a technician power on offline storage, there may be instances where the number of requests exceeds available resources. In such cases, authority 108 can queue requests based on available resources. Constrained resources within the data center can include:

a. Technicians;

b. Servers to connect disks to;

c. Electricity to power servers and disks; and

d. Physical space for “powered on” servers or disks.

In some cases, authority 108 can be made aware of capacity limits of some resources. For example, authority 108 can be made aware that the technicians only have 10 units of power available at one time to power on storage devices for user requests. If 50 requests arrive at the same time, and each request requires 1 unit of power, only the first 10 requests can be handled at first. Then, as requests are completed and power resources made available again, additional requests in queue can then be completed.

As noted, authority 108 can be configured to provide a “File-ready” notification. Authority 108 can actually be configured to make the end user aware that a request task has been completed via numerous methods. For example, the user could request that a file, or set of files, be moved from one storage type to another, e.g. move from online to offline, and can then receive an email notification that this request has been completed. Other methods of notification may include:

a. Internet URL callbacks;

b. SMS/text message; and

c. Instant messaging.

Authority 108 can also be configured to periodically test files for data integrity, and make the results of these tests available programmatically to the end user. Thus, authority 108 can be configured to: (a) proactively test files for data integrity so the user can be more assured that they will be available when they need to be requested, and (b) provide feedback to end user to assure them that their files are safe and still valid. For example, in certain embodiments, the system will load files for reading and then compute a cryptographic hash of the file to compare against previously computed hashes. This can be performed at user defined intervals, e.g. every hour, 5 hours, week, or month. If the hashes match, then the file is still valid. If not, it is invalid and needs to be replaced with another copy that might exist on another part of system 100. Users can query these “exercise logs” to verify that their files are being checked and that there is no problems with the stored data. Hashes will be discussed in more detail below.

In certain embodiments, when the “file exercise” process identifies a file or set of files that is not valid or potentially at risk, authority 108 can automatically create additional copies from the other still-valid copies to restore the correct number of perfectly valid copies. Once the correct number of valid files is back in place, then authority 108 can delete or retire the files that were at risk.

It should also be noted, that authority 108 can be configured to provide Content-Addressable Storage (CAS) service. Conventional data storage services typically only allow users to reference and access stored data via: (a) service-assigned file identifiers, or (b) an explicitly user-defined file name and file hierarchy. Contrastingly, authority 108 can be configured to allow the user to reference or access specific data objects by file identifiers that can be computed by the accessing client without having to query the storage system.

Such a CAS service works by allowing the user to query the storage service for an object that may or may not exist in storage 110, by generating a non-proprietary “signature” or “hash” of the desired data object, e.g. and MD5 or SHA1 hash. An action to be performed on a data object is requested by referencing the associated hash, rather than a system assigned identifier like a filename or path. So a user can query the system for data, without having ever previously loaded the file system metadata or being aware of its contents.

Authority 108 can even, in certain embodiments, allow multiple identifiers to be used to query for specific objects. For example, a user can use an industry-standard MD5 hash to identify one file for an operation, or they can use an industry-standard SHA1 hash. Additional identifiers can be added as well depending on the needs of a particular implementation.

In certain embodiments, a CAS and a folder hierarchy can be used together. Authority 108 can also be configured to support a flexible and extensible metadata system that can be used to associate name/value pairs to objects in storage 110. This can be used to model a traditional storage system's folder hierarchy within the metadata. Doing so creates either option for end-users—they can choose to access the storage system strictly using the CAS methods, or traditional folder hierarchies, or both at the same time.

Authority 108 can also be configured to implement what can be referred to as a single instance storage model. Implementation of single instance storage minimizes redundant data across all users' accounts, not just within a single user's account as in conventional systems. The application of this single instance storage allows authority 108 to distribute the end-user's cost to store a file by computing the proportional amount of disk space the user is consuming to store that file. For example, if five users are all storing one copy of the same 100 MB file, authority 108 can be configured to only charge each of those five users 20 MB of storage space—the proportional amount shared by the five users. In this way, an individual user benefits as more unknown and unrelated users stored the same or similar files.

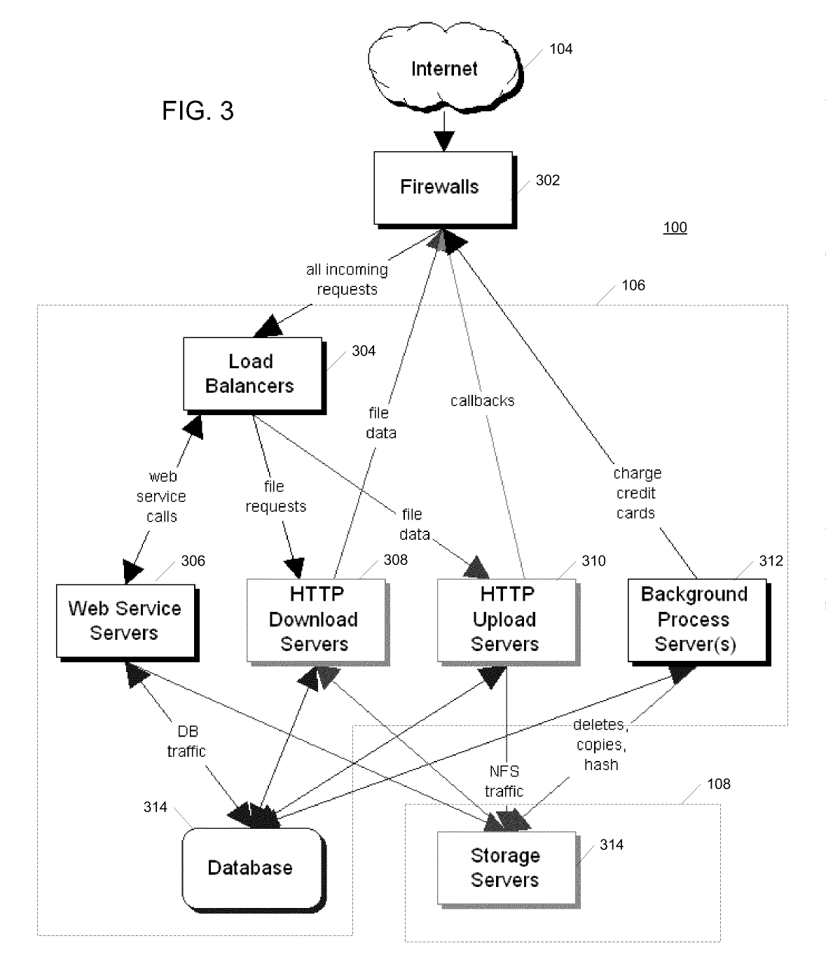

FIG. 3 is a diagram illustrating system 100 in more detail. As can be seen, system 100 can comprise a firewall between network 104 and authority 108. Further, as can be seen, services 106 can comprise web services, which can include account creation, management, reporting, and the actual primary upload, download, rename, delete, etc., functions. Some concepts concerning system 100 will first be explained and then a more detailed description of services 106 will follow.

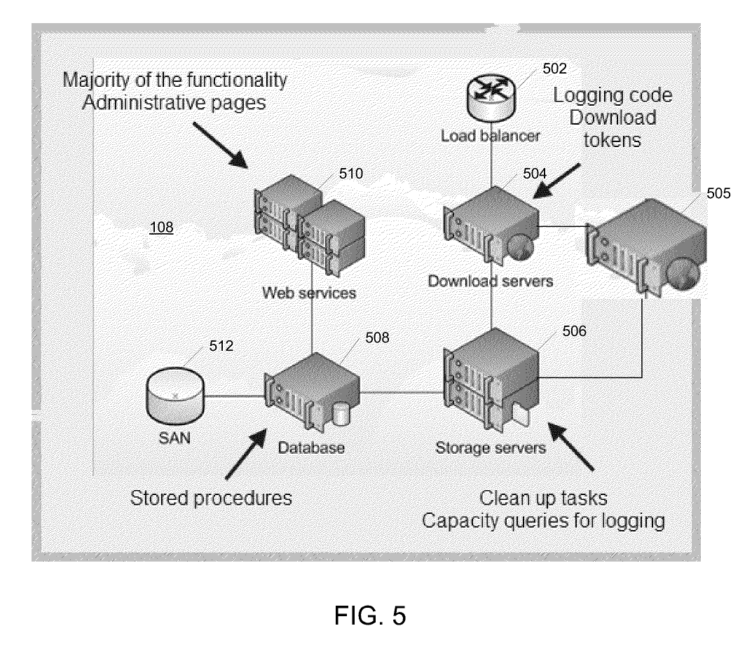

Depending on the embodiment, the software and database infrastructure can be entirely Microsoft™-based, e.g., Windows™ 2003 server, SQL Server 2005, and .NET 3.0 web services. The backend “storage servers” (see FIG. 5) can be based on commodity hardware that run, e.g., Ubuntu (Debian Linux) and expose their “storage shares” via NFS to the front-end Window's servers. It will be understood, however, that the above example configurations are by way of example only.

System 100 can be configured to provide file storage and retrieval only. As such, concepts of buckets or folders like a traditional file system are generally not supported. Rather, Files can be organized, searched, and queried by fileid, filename, hash, e.g., SHA1, MD5, or other fast hash, or metadata, e.g., name/value pairs, assigned to them. Thus, for example, a third party application can use the metadata name/value pair system to maintain a “fake” folder tree hierarchy, e.g., name=parent folder, value=parent folder id.

Files can be organized into virtual files, e.g., what the user “sees” in their account, logical files, e.g., bit-for-bit unique files stored in the system, and physical files, actual files on disk. Two hashes, e.g., can be used to identify bit-for-bit identical files after an upload is complete. Initially, it can be assumed that all files are unique, i.e., nothing is already uploaded. Accordingly, initially there can be a 1:1 mapping of virtual files to logical files.

Internal counters or IDs should not be exposed to end users, but end users should be able to reference files by an ID. Accordingly, in certain embodiments, for each virtual file, there can be a VirtualFileID, an internal counter that increments for all files in storage 110, and a UserFileID that starts from 0 for each user. These can then be mapped against each other.

As noted, two hashes can be computed for each file uploaded to enable: (a) search for duplicate data already in the system, and (b) allow the user to reference a file by its hash via public domain functions. These hashes can be based on the SHA1 and MD5 algorithms and can be named FileHashSHA1 and FileHashMD5. In addition, a custom fast hash, FastFileHash, can also be used. FastFileHash can be a simple, custom file hash to quickly identify if a file might be in storage 110. The FastFileHash can be configured to compute on any size file in less than, e.g., 0.1 seconds, but does not necessarily guarantee that the file is in storage 110. For example, if this function fails, then the file definitely is not already in storage 110. But if it finds a FastFileHash collision, then the file might be in the system and it will be necessary to compute the FileHashSHA1, which might take a while on big files. FastFileHash can not be used to reference a file, it's only to determine if a file is already in the system.

As illustrated in FIG. 3, services 106 can comprise five important services: (1) Web services 306, which can be configured to handle all web service calls including uploading files, (2) download services 304, which can be configured to handle delivering files requested by end users from, e.g., URLs generated from a call to a web services function GetDownloadURL, (3) storage services 306, which can be used to run the operating system to expose file shares. Storage services 306 can also include a small “processing” web service that can handle requests to generate hashes for files, either locally or on another storage server. In other embodiments, storage services 306 can be configured to handle additional requests, such as transcoding or resizing media files.

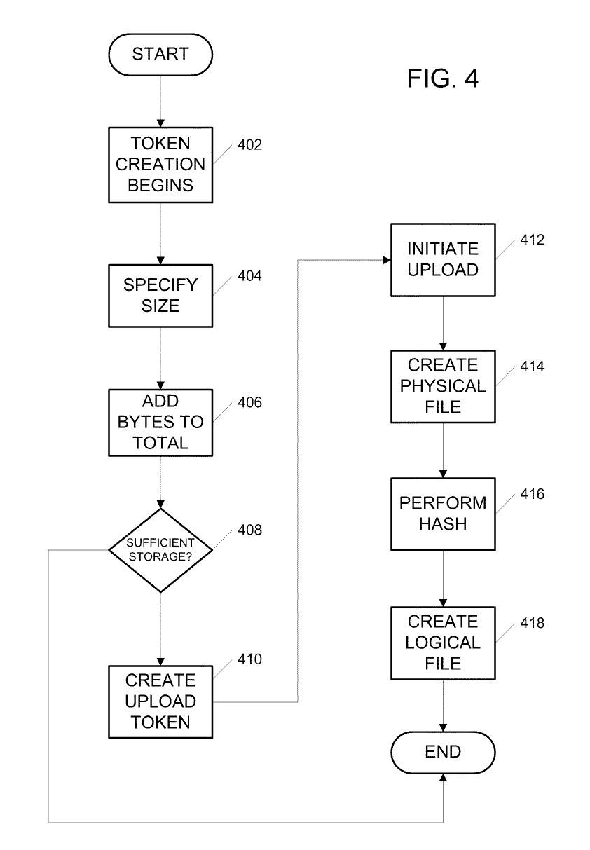

Service 106 can also include (4) Database services 314, which can be configured to provide, e.g., SQL server database functions and all necessary procedures related thereto. No actual end-user data files are generally stored here, just account information and the “virtual” file system pointers to the files in storage 110. Service 106 can also include (5) background processes 312, which can be configured to couple independent processes that can run in the background, or on a timer on the web services servers (see FIG. 4) to handle recurring tasks, e.g., clean up deleted files, generate hourly logs for report data, etc.

Web Services 302 can be configured to implement a plurality of functions. Some of these functions will be described here including the CreateUser function. This method shall create a new user within system 100 during registration. User registration can involve the following parameters:

1. Username;

2. Password;

3. Email address;

4. First name; and

5. Last name.

Optional parameters can include:

1. Company name; and

2. Telephone number.

The CreateUser function can also be designed to prevent a denial of service attack, which could occur if there are millions of registrations from one address.

The UpdateUserInfo function can allow a user to update his/her information stored on the server. The fields that can be editable can include information collected at account creation.

User's can also be allowed to add and remove multiple email addresses for their account. For example, the GetEmailAddresses function can return a list of email addresses. The AddEmailAddress can allow addition of an address for the user. The RemoveEmailAddress function can mark the user's address as “IsDeleted.” The SetPrimaryEmailAddress can accept the user's email as a parameter and mark the email as “primary” in the database.

The DeleteUser function can mark a user as “deleted” in the database and prevent further login, upload, or download to the account. Note that the user is only marked as deleted not physically removed. The user can be required to be logged in to remove their account. Administrators can have the ability to remove account without the need to login as the user. In such instances, the administrator's token shall be used for authentication. Tokens are described in detail below.

The Login function can be used to establish new sessions for making calls on behalf of an account. The Login function can return a “session token” that is used in all subsequent calls. That session token can allow the user to only access or modify files in that user's account. Authority 108 can be configured to add a record of the user's login to a database table, along with the user's IP address.

The Logout function can be used to cancel a created session and ensure that the session token is no longer valid. A session token can automatically expire if no activity has occurred over a period of time. Depending on the embodiment, session expiration time can be configurable.

The Upload function can be configured to allow the user to upload a new file to storage. The Upload function can require the user to be “logged in” and submit their current session token. Uploaded data shall be written/streamed straight through to the storage server for loading into storage 110. Streaming, reliability, chunking, and MTOM encoding can all be configurable through configuration files and encodings can be modified within the limits of WCF. Resumable uploads can be supported, e.g., to the extent that MTOM can provide such support. Duplicate file detection can be performed after the file has finished uploading. Duplicate file handling will be described in detail below.

The GetUploadToken can be configured to generate a unique string value (token) to allow direct HTTP uploading. The unique string shall be long enough such that is cannot simply be guessed. For example, the token can be a 256 bit token. The token shall be stored in the UploadTokens database and shall include: UserId, TokenCreatedDateTime, TokenExpiresDateTime. All uploads, whether by API, POST or PUT will use upload tokens internally or externally. This enables a unified mechanism for file creation.

Direct upload capabilities allow users to post a file to an upload server (see FIG. 5) along with an upload token. The uploaded file shall be stored directly to a storage server. The upload token shall be invalidated to prevent others from using it again. The logs shall be updates as described in the logging section. The client shall be able to specify an upload completion callback URL. Duplicate file detection can be performed after the file has finished uploading. The server can be configured to post to the callback URL certain results, such as:

i. Success status: fail/ok;

ii. FileId of the file on the server; and

iii. The expired UploadToken used to execute the upload.

FIG. 4 is a flow chart illustrating an example process for uploading a file using tokens in accordance with one embodiment. First, in step 402, prior to data transfer, token creation begins by allocating the storage necessary for the transfer (ContentLength). In certain embodiments, the user must specify, in step 404, either the exact file size, or an upper bound for allocation when creating the token. In step 406, bytes (the ContentLength) allocated via the token are added to the user's “TotalUserFileBytesPending” counter. In certain embodiments, the TotalUserFileBytesPending along with “TotalUserFileBytes” both count towards the “StorageLimit” assigned to that user. If insufficient storage remains for that user, as determined in step 408, then the token creation fails.

When it is determined that sufficient storage remains in step 408, then in step 410, the upload token can be created and file upload can be initiated in step 412. In step 414, the physical file can then be created in storage 110. Thus, in this example, the physical file is created only when the data transfer itself is initiated. Depending on the embodiment, the requested file size can be pre-allocated on the disk during upload to help with performance and avoid fragmentation.

In step 416, a hash is performed on the uploaded file and a logical file is created in step 418. Thus, depending on the embodiment, the physical file record does not have a logical file parent until hashing is complete, since the hash is not known until then. In such instances, there is a need to maintain referential integrity in the database, so a static placeholder, e.g., LogicalFile (ID=1) can be used to contain all active uploads of physical file records.

During upload (step 412), when a data chunk is received, web service 302 can be configured to determine whether the TotalBytesReceived+chunkLength>ContentLength and can keep track of the TotalBytesReceived. Web service 302 can then create an UploadLog that can comprise the PhysicalFileID, StartByte, EndByte, StartUploadDateTime, EndUploadDateTime, UploaderIP, and TotalUploadBytes+=(EndByte−StartByte). When the data transfer is complete it is possible that the allocated ContentLength was bigger than the actual final content transferred or the TotalBytesReceived. In such instances, web services 302 can be configured to adjust for actual content length, if there was a difference, and update the UploadToken to set the ContentLength=TotalBytesReceived. If the TotalBytesReceived exceeds the ContentLength, then an exception can be generated.

As noted above, a single instance storage model can be used. Thus, if the hash performed in step 416 shows that the current logic file matches an existing logic file, then the just created physical file can be deleted as a new copy of the file is not needed. Depending on the embodiment, the same logical file used for the existing file can be used or a new logical file can still be created. This process can be related to duplicate file removal, which is described below.

Duplicate file removal can also be implemented to help save disk space. A duplicate file is detected by checking for matching hashes. If a matching hash is found, the virtual file can be updated to point to the oldest instance of the physical file. The new instance of the physical file can be marked for removal, and can be removed, e.g., by a cleanup task. Duplicate file removal can be implemented as a recurring task.

At this point, the upload token can then be deleted. Also, if data transfer is cancelled or the token expires, then the physical file can be deleted. But depending on the embodiment, if an unranged data transfer fails and the token is not expired then a retry can be allowed.

Returning to the description of web services 302, the GetDownloadURL function can be configured to generate a URL for an uploaded file given an identifier to the virtual file. Identifiers include the UserFile, FileHashMD5, FileHashSHA1.

In certain embodiments, a download token can be used with each download. The download token can be a string pointer to a virtual file. A download token can have an expiration time, e.g., set in the database in number of seconds. A download token can also have an expiration threshold based on “number of downloads” and “number of IPs”. When the number of downloads or number of IPs reaches the limited defined for the token, then the token can be disabled.

Depending on the embodiment, download URLs can have the form: http://d.companyx.com/AHS7HEOD9AK2/apple.jpg, where the letter “d” represents the load balancer (discussed below), the first path element after the hostname represents the token, and the final path element is a user friendly filename. The download servers (see FIG. 5) can have a custom http request processor to parse the download token. The http request processor can be configured to grant or deny requests based on certain rules, e.g., limited to what is defined in the requirements for upload and download transfer limits. In certain embodiments, authority 108 can be designed to support download resuming.

Each download can be logged to the DownloadLog table, along with the IP address, start byte, end byte, start time/date and end time/date. Each upload can be logged into the UploadLog table, which can include the VirtualFileId, PhysicalFileId, StartUploadDateTime, EndUploadDateTime, and UploaderIP.

The RenameFile function can be configured to allow the user to edit the virtual file filename. The physical filename of the file should remain the same (PhysicalFileId).

The DeleteFile function can be configured to mark a virtual file as deleted. In certain embodiments, a background process can then remove the physical file from disk and all the rows from the database. The UndeleteFile function can be configured to then unmark the virtual file as deleted.

The SetMetadata function can be configured to allow the end user to add one or more name/value metadata pairs to a virtual file. The DeleteMetadata function can be configured to delete key/value pair given the file ID and the key.

The SearchStoredFiles function can be configured to allow the end user to query for a list of files matching “search criteria”. The SearchStoredFileTotals function can be configured to allow the end user to query for a collection of “totals” related to the files which match search criteria. The SearchUploadLog function can be configured to accept a collection of filters and return a dictionary of values. In certain embodiments, accepted filters can include: VirtualFileId, UploadDateStart, UploadDateEnd, and UploadIp. The filters can be processed using AND logic and the results can include: VirtualFileId, UploadDate, and UploaderIp.

In other embodiments, the following parameters can be support as search filters: UserFileID, Filename with wildcards), FileHashSHA1, FileHashMD5, Metadata name, value (with wildcards), Byte Range, Date Range, which can be a date stored for files or date uploaded, and the IsDeleted parameter. The search output can consist of a list of “file search result” objects. Each result object can contain: Filename, FileHashSHA1, FileHashMD5, Size bytes, UserFileID, CreatedDate, LastAccessDate, IsDeleted, and all metadata. Metadata is discussed in more detail below.

Similarly, the SearchDownloadLog function can be configured to accept a collection of filters and return a dictionary of values. Accepted filters can include: VirtualFileId, DownloadDateStart, DownloadDateEnd, DownloadToken, and DownloaderIp. The filters can be processed using AND logic and the results can include: VirtualFileId, DownloadDate, DownloadToken, DownloaderIp, StartByte, and EndByte.

The SearchLoginLog function can be configured to accept a collection of filters and return a dictionary of values. Normal system users can be able to access only their own login history, while administrations can have the ability to query all login history. Accepted filters can include: UserId, LoginDate, and LoginIP. The filters can be processed using AND logic and the results can include: UserId, LoginDate, and LoginIP

The SearchPaymentLog function can be configured to allow appropriate columns from the payment table to be searchable.

The Forgot password function can be configured to accept a user's email as a parameter and send the user an email with the password, if the user is found in the database.

The SetBillingData function can be configured to allow a user to set: type of card, name on card, card number, expiration, CCV, billing address 1, 2, city, state, zip, etc.

Using, e.g., the above function provided by web services 302, a user can create and manage their account and can upload files. For file storage, system 100 can use three layers of abstraction: virtual files, logical files, and physical files. Virtual files can provide an end user view of the file system. Logical files can be used internally as an abstraction layer to provide flexibility. Physical files can be used to physically store data.

Physical file names can be based on a hex form of the primary key of the file in the database. It can be advantageous to have the ability to map file system objects back to the database key, and to keep filenames globally unique rather than tracking separate sets of counters for each share. In certain embodiments, the primary key is a 64 bit signed integer, assigned sequentially. Often, the high-order DWORD of this identifier is likely to be little-used, so some leading zeroes can be collapsible. In order to keep the folders manageable, and browseable, a (soft) target limit of either 4096 or 16384 items per folder can be used, depending on the requirements of a particular implementation. 4096 is often seen as a reasonable trade-off point, but 16384 can be managed efficiently by NTFS as long as folder names are kept short and represent a dense hash.

In many embodiments, no filename part shall be longer than 8 characters. Identifiers can be allocated sequentially to minimize the occurrence of large number of sparsely populated folders. However this could possibly still occur after files are moved or deleted. Thus, in certain embodiments, maintenance cycles can be used to combine folders as needed.

Scheme 1 below assumes that there will be around 16 shares and that files are evenly distributed cross the shares. If, for example, there were 64 shares, then the statistically expected maximum number of files per folder would be 1024. Scheme 2 is an alternative that aims for 16384 files per folder, assuming 64 shares with available space in the system as a whole.

Scheme 1:

16 shares, average 4096 files per folder:

000000GH-IJKLMNOP maps to /GHI/JKL/MNOP

ABCDEFGH-IJKLMNOP maps to /ABCDEF/GHI/JKL/MNOP

Scheme 2

64 shares, average 16384 files per folder:

00000FGH-IJKLMNOP maps to /FGH/IJK/LMNOP

ABCDEFGH-IJKLMNOP maps to /ABCDE/FGH/IJK/LMNOP

Thus, when a file is uploaded it can be given a FileId, VirtualFileID, and UserFileID. The UserFileID can be an auto number that is user specific and user-facing. Users generally will not have the ability to view internal auto numbering.

Other functions that can be performed by authority 108 include virtual file actions which are actions that modify the state of a virtual file. All virtual file actions are to be recorded in the VirtualFileActionLog table:

1. VirtualFileID;

2. ActionType; and

3. ActionDateTime.

The following methods are examples of virtual file actions: GetDownloadURL, RenameFile, DeleteFile, UndeleteFile, SetMetadata, and DeleteMetadata.

Authority 108 can also be configured to perfume snapshot logging which is logging done on a regular interval to record that “state” of a user's account or system. For example, the SeverSnapshotLog function can add a record to the ServerSnapshotLog table, which can include: DatacenterID, TotalServerCount, TotalServersOnlineCount, and SnapshotDate. The SeverShareSnapshotLog function can add a record to the ServerShareSnapshotLog table, which can include: ServerID, SharesCount, TotalShareCapacityBytes, TotalShareIsWriteableCapacityBytes, SharesOnline, and SnapshotDate. Determining server capacity can require a small bit of code to run on all storage servers (see FIG. 5). The storage server code can run on the same port number on all servers.

A user snapshot can be generated by gathering data from different tables and adding a record to the UserSnapshotLog table, which can include: UserID, TotalVirtualFileCount, TotalVirtualFileBytes, TotalLogicalFileBytes, TotalUploadCount, TotalUploadBytes, TotalDownloadCount, TotalDownloadBytes, TotalVirtualFileActionCount, SnapshotDate.

Authority 108 can be configured to assign a unique virtual ID to each file in the virtual file system. Authority 108 can be configured to use a separate ID counter for each user, in addition to an internal counter for all virtual files. For example, userJoe can start with file number 1 when signing up for an account.

Recurring tasks can run on each storage server at scheduled intervals. The intervals for the tasks can be defined in a central location to allow administrators to control the process. Where desirable, background tasks should be schedule to run using a message queue algorithm. Cleanup file task can read the database to find files that are marked for deleting. If a file is marked for deleting, it can be removed and the associated virtual and logical files can also be fully removed from the database. A cleanup database task can scan the token tables to determine if any of the tokens expired. Expired tokens can then be removed. Cleanup users task can remove files of users who have certain account restrictions, e.g., free accounts and payment-overdue. Snapshot task can be initiated by one of the admin web servers. Such a task can be used to gather information from all storage servers. Such a task can log information as defined in the logging requirements. A process billing task can iterate through all paying users and bill each users account. Billing can follow rules as described in the “payment processing” section.

Transfer totals can be calculated based on upload logs and download log. Storage totals can be calculated based on files in a user's account. A user's transfer limit shall be checked during upload and download attempts to determine if the transfer quota has been exceeded. A user's storage limit shall be checked before a file is committed to storage. If a user's storage quota is hit and the user is attempting to upload via the web service, an appropriate error code can be returned by the web service. If a user's storage quota is hit and the user is attempting to upload via direct http, an appropriate HTTP response can be returned. When a user's transfer quota is hit, any attempts to download shall return appropriate HTTP responses.

FIG. 5 is a diagram illustrating another example embodiment of storage authority 108. In the example of FIG. 5, an example server architecture is illustrated, whereas FIG. 3 illustrated services that can be configured to run on the servers comprising authority 108. As can be seen, authority 108 can comprise a load balancer 502, download server(s) 504, upload server(s) 505, storage server(s) 506, database 508, web service server(s) 510 and SAN 512.

Load balancer 502 can be configured to balance download request between download servers 504 to prevent one server from becoming overloaded and increasing the latency in the system. Similarly, load balancer 502 can be configured to balance the upload requests between upload servers 505.

Download servers 504 can, e.g., be Windows™ 2003 based. Further, download servers 504 can be HTTP servers. Severs 504 can be configured to handle all file transfers for previously uploaded files. Servers 504 can be configured to read data straight from the storage servers 506.

Storage servers 506 can also, e.g., be Windows 2003 based. Servers 506 can include scripts to clean up files, as described above. In one example installation, there are 60 storage servers 506, which include 960 hard disks as well as other storage media.

Upload servers 505 can also, e.g., be Windows™ 2003 based. Servers 505 can be configured to handle all direct HTTP uploads to storage servers 506. As discussed above, custom http handlers can be configured to run on upload server 505 and can verify tokens and direct the files to the appropriate storage server 506.

Database server 508 can be configured to, e.g., run SQL 2005 partitions to make use of a SAN 512.

Web services servers 510 can be configured to handle all the web service calls including background processes and reoccurring tasks, such as those discussed above. As discussed above, in certain embodiments, uploads can be requested, in certain implementations or instances via web services. Uploads that are requested via web services can be written straight through web service servers 510 to the appropriate storage server 506. Web service servers can also be configured to implement certain administrative pages. For example, in one implementation, the administrative pages can be deployed to the first web service server 510.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A power aware data storage system, comprising:
storage configured to store physical data files;
a storage authority coupled with the storage, the storage authority configured to control uploading of files to the storage, and downloading of files from the storage;
web services configured to interface the storage authority with end users; and
a power consumption application configured to compute power consumption information for each physical data file stored in the storage and to report the power consumption information via the web services.

2. The power aware data storage system of claim 1, wherein the power consumption information comprises a power consumption rate.

3. The power aware data storage system of claim 1, wherein the power consumption in formation comprises a total power consumed.

4. The power aware data storage system of claim 1, wherein the storage authority comprises at least one upload server configured to handle all direct uploads to the storage server.

5. The power aware data storage system of claim 4, wherein the storage authority comprises at least one download server configured to handle all file transfers of previously uploaded files from the storage server.

6. The power aware data storage system of claim 5, further comprising a plurality of download servers, and wherein the storage authority comprises a load balancer configured to balance requests to download physical files between download servers.

7. The power aware data storage system of claim 5, further comprising a plurality of upload servers, and wherein the storage authority comprises a load balancer configured to balance requests to upload physical files between upload servers.

8. The power aware data storage system of claim 5, wherein the download servers are HTTP servers.

9. The power aware data storage system of claim 1, wherein the storage authority further comprises a database server.

10. The power aware data storage system of claim 1, wherein the power consumption application is further configured to generate storage forecasts based on available and used power consumption.

11. The power aware data storage system of claim 10, wherein the forecasts is based on the amount of floor space, cabinet space, physical hard disk a space, or a combination thereof that is available.

12. The power aware data storage system of claim 1, wherein the storage comprises several types of storage that are associated with different access times and power consumption, and wherein the web services are configured to allow the end users to select the type of storage for each physical file or group of physical files.

13. The power aware data storage system of claim 12, wherein the types of storage include online, nearline, and offline.

14. The power aware data storage system of claim 13, wherein a different price is associated with each type of storage.

15. The power aware storage system of claim 1, wherein the web services are further configured to allow the user to adjust at least one of the following performance characteristics for each physical file: time to first byte, data integrity, maximum available throughput, total power consumed, recovery time objective, and recovery point objective.

16. The power aware storage system of claim 1, wherein the web services are further configure to allow the user to control how many copies of each physical file are stored and in what type of storage each copy is stored.

17. A power aware data storage system, comprising:
storage configured to store physical data files, the storage comprising several types of storage that are associated with different access times and power consumption;
a storage authority coupled with the storage, the storage authority configured to control uploading of files to the storage, and downloading of files from the storage;
web services configured to interface the storage authority with end users via the internet and to allow the end users to select the type of storage for each physical file or group of physical files; and
a power consumption application configured to compute power consumption information for each physical data file stored in the storage and to report the power consumption information via the web services.

18. The power aware data storage system of claim 17, wherein the types of storage include online, nearline, and offline.

19. The power aware data storage system of claim 18, wherein a different price is associated with each type of storage.

20. The power aware storage system of claim 17, wherein the web services are further configured to allow the user to adjust at least one of the following performance characteristics for each physical file: time to first byte, data integrity, maximum available throughput, total power consumed, recovery time objective, and recovery point objective.

21. The power aware storage system of claim 17, wherein the web services are further configure to allow the user to control how many copies of each physical file are stored and in what type of storage each copy is stored.
